(19) United States
(12) Patent Application Publication
(10) Pub. No.: US 2018/0135654 A1
(43) Pub. Date: May 17, 2018

(54) CENTRIFUGAL FAN MODULE

(71) Applicants: Inventec (Pudong) Technology Corporation, Shanghai (CN); INVENTEC CORPORATION, TAIPEI CITY (TW)

(72) Inventor: Kuo-Chi TING, TAIPEI CITY (TW)

(21) Appl. No.: 15/472,283

(22) Filed: Mar. 29, 2017

(30) Foreign Application Priority Data
Nov. 17, 2016 (CN) 201611019255.8

(51) Int. Cl. F04D 29/66; F04D 17/16; F04D 29/42; G06F 1/20

(52) U.S. Cl. CPC F04D 29/665; G06F 1/20; F04D 29/4226; F04D 17/16

(57) ABSTRACT

A centrifugal fan module includes a housing and a fan. The housing includes a top cover, a bottom cover, a first side wall, and a plurality of second side walls. The first side wall is connected between the top cover and the bottom cover to surround and form an accommodating space and has a plurality of through holes therein. The second side walls are connected between the top cover and the bottom cover, are connected to the first side wall, and are located outside of the accommodating space. A chamber is formed between the first side wall and any one of the second side walls, and the accommodating space is communicated with the chambers through the through holes respectively. The fan is rotatably disposed in the accommodating space.

### CROSS-REFERENCE TO RELATED APPLICATION

This application claims priority to Chinese Application Serial Number 201611019255.8, filed Nov. 17, 2016, which is herein incorporated by reference.

### BACKGROUND

### Field of Invention

The present invention relates to a centrifugal fan module.

### Description of Related Art

In recent years, with the rapid advances in computer technology, the operating speed of computers has continued to increase. In addition, the increase of the number of personal computers in the workplace and at home may cause some problems in the computing environment, and one of these problems is that if a computer is in operation, there may be noise generated by the computers. For example, a fan for a central processor unit and a power supply in the computer may produce noise during operation.

Generally speaking, in order to prevent the electronic elements, such as, a power supply, a central processing unit (CPU), and a graphics processing unit (GPU), inside a computer from overheating, in which may lead to temporary or permanent failure of the electronic elements, a fan is usually configured with the electronic elements for heat dissipation, thereby removing the thermal energy generated at the time of the high-speed operation of the electronic elements, and thus lowering the temperature of the electronic components themselves. This is important for the high speed operation of a computer system. However, the rotation of the fan may generate vibration noise. When a frequency of the vibration noise falls within the receiving range of the human ear, it will affect the user's sense of hearing, and will affect the user's operational comfort on the computer. Therefore, how to reduce the volume of noise is a problem that the person skilled in the art has been faced with.

### SUMMARY

In order to solve the problems of the prior art, the present disclosure provides a centrifugal fan module including plural chambers to respectively communicate with an accommodating space where a fan rotatably disposed therein.

The present disclosure provides a centrifugal fan module includes a housing and a fan. The housing includes a top cover, a bottom cover, a first side wall, and a plurality of second side walls. The first side wall is connected between the top cover and the bottom cover to surround and form an accommodating space and has a plurality of through holes therein. The second side walls are connected between the top cover and the bottom cover, are connected to the first side wall, and are located outside of the accommodating space. A chamber is formed between the first side wall and any one of the second side walls, and the accommodating space is communicated with the chambers through the through holes respectively. The fan is rotatably disposed in the accommodating space.

In some embodiments of the present disclosure, at least two of the chambers have different volumes.

In some embodiments of the present disclosure, each of the through holes of the first side wall has a section, the section is substantially parallel to the first side wall, and at least two of the sections of the through holes have different areas.

In some embodiments of the present disclosure, the section of the through hole is a rectangle, two ends of a side of the rectangle are adjacent to the top cover and the bottom cover respectively and connected to the top cover and the bottom cover.

In some embodiments of the present disclosure, one of the chambers has a volume, the through hole of the first side wall connected to the one of the chambers has a section and a depth, the section is substantially parallel to the first side wall and has a section area, the depth is substantially equal to a thickness of the first side wall, sound generated by the centrifugal fan module during operation has a sound speed and at least a frequency, and a resonance frequency satisfies the following equation:

fr=f=c/2n(A/VD)^{1/2};

wherein f represents the frequency of sound, fr represents the resonance frequency, c represents the sound speed, A represents the section area of the through hole, V represents the volume of the chamber, and D represents the depth of the through hole.

In some embodiments of the present disclosure, the resonance frequencies of at least two of the chambers are different.

In some embodiments of the present disclosure, the chambers surround an outer side of the first side wall.

In some embodiments of the present disclosure, the second side walls are sequentially connected to each other.

In some embodiments of the present disclosure, the first side wall and the second side walls are connecting parts of a one-piece object.

According to the above-described structural arrangement, the housing of the centrifugal fan module includes the top cover, the bottom cover, the first side wall, and a plurality of second side walls. A chamber is formed between the first side wall and any one of the second side walls, and the accommodating space is communicated with the chambers through the through holes respectively. In doing so, the size of the chambers and the through holes of the centrifugal fan module are designed in accordance with the volume of noise with a large bandwidth generated by the centrifugal fan module at the time in operation.

In the configuration, the centrifugal fan module of the present disclosure uses the Helmholtz resonance theory, in which the natural frequency of one of the chambers is substantially the same as a frequency generated by the centrifugal fan module at the time in operation, to consume the energy of sound in the aforementioned frequency, thereby reducing the volume of sound, and thereby enabling the centrifugal fan module to reduce the volume of sound and absorb the energy of sound. Consequently, the centrifugal fan module of the present disclosure may reduce the volume of sound having a broader bandwidth by a plurality of chambers. Furthermore, the chambers of the present disclosure surround the outer side of the first side wall, thereby reducing the volume of sound in a designed frequency for a multi-angle range.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a centrifugal fan module according with some embodiments of the present disclosure;

FIG. 2 is an exploded view of a centrifugal fan module according with some embodiments of the present disclosure;

FIG. 3 is a top view of a centrifugal fan module according with some embodiments of the present disclosure has been simplified to omit a top cover and a fan for a better understanding of the embodiments of the present disclosure;

FIG. 4 is a perspective view of a partial structure of a centrifugal fan module according with some embodiments of the present disclosure;

FIG. 5 is a top view of a partial structure of a centrifugal fan module according with some embodiments of the present disclosure; and

FIG. 6 is a top view of a partial structure of a centrifugal fan module according with some other embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

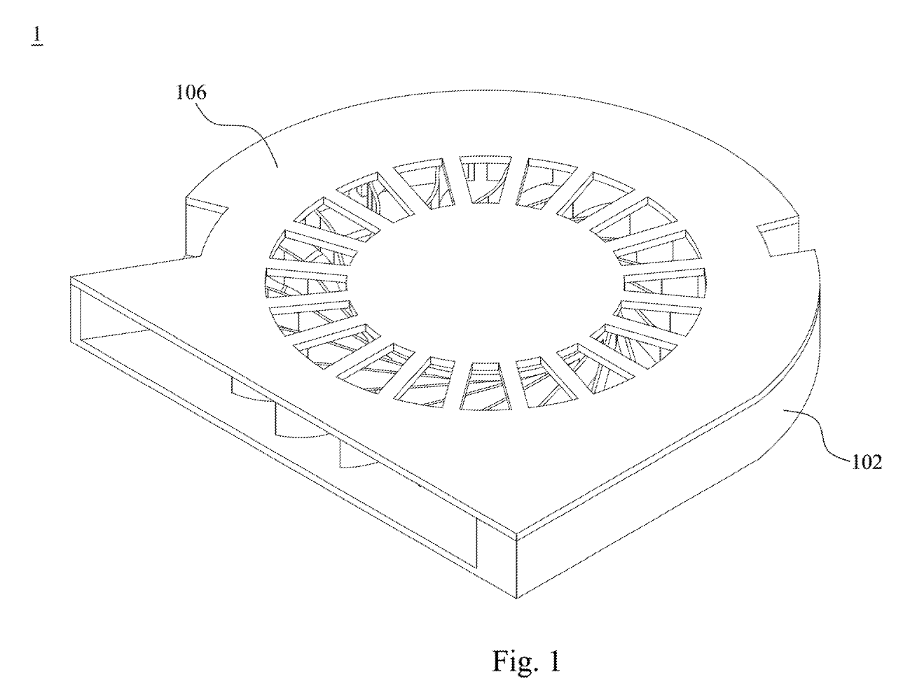

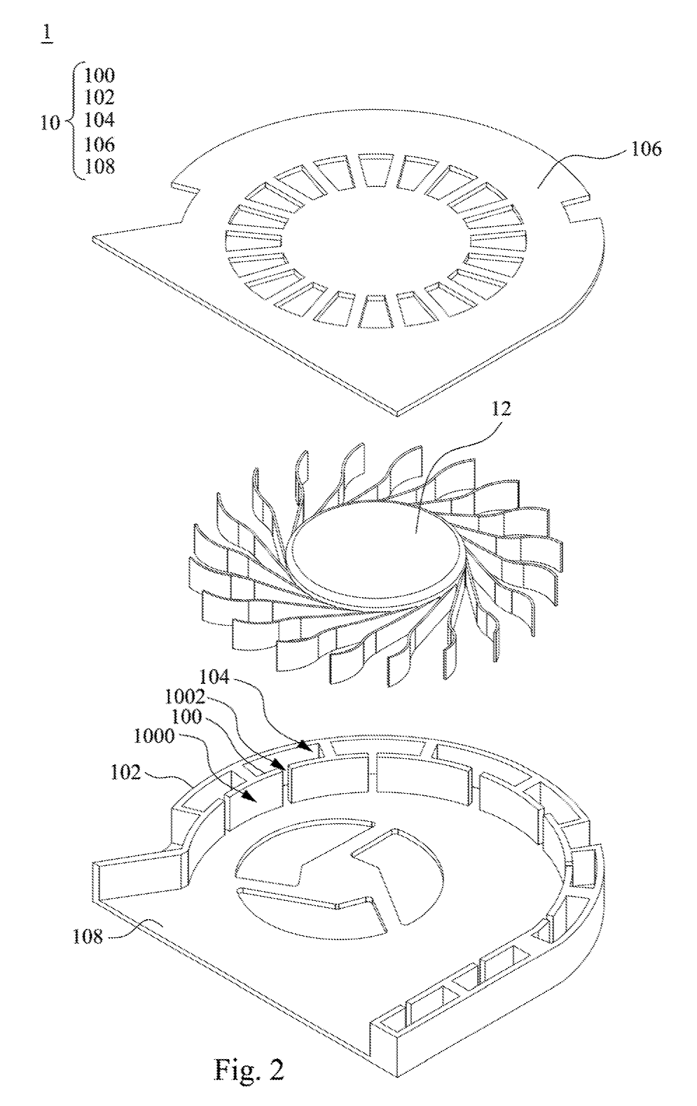

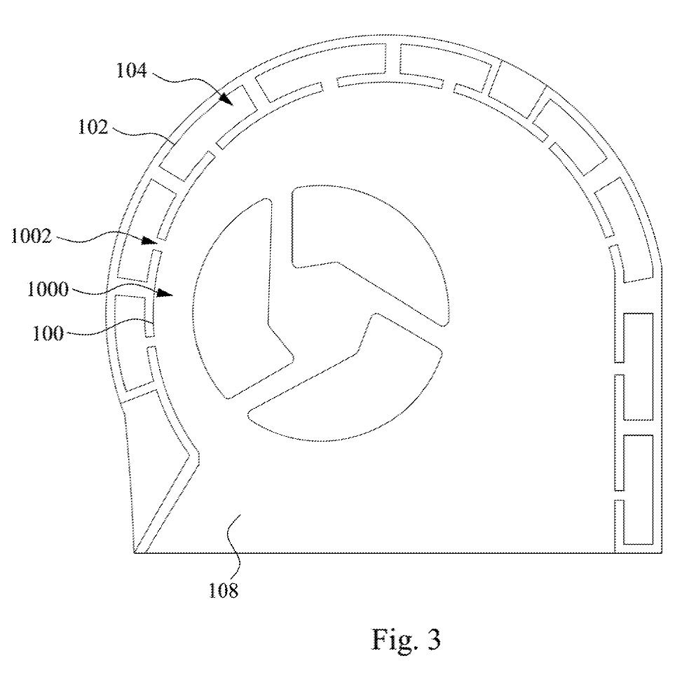

Reference is made to FIGS. 1-3. FIG. 1 is a perspective view of a centrifugal fan module 1 according with some embodiments of the present disclosure. FIG. 2 is an exploded view of the centrifugal fan module 1 according with some embodiments of the present disclosure. FIG. 3 is a top view of the centrifugal fan module 1 according with some embodiments of the present disclosure. It is understood that FIG. 3 has been simplified to omit a top cover 106 of a housing 10 and a fan 12 of the centrifugal fan module 1 for a better understanding of the embodiments of the present disclosure. The structure and function of the elements and the relationship therebetween are described in detail hereinafter.

As shown in FIGS. 1-3, in the embodiment, the centrifugal fan module 1 includes the cover 10 and the fan 12. The housing 10 includes the top cover 106, a bottom cover 108, a first side wall 100, and a plurality of second side walls 102. The first side wall 100 is connected between the top cover 106 and the bottom cover 108 to surround and form an accommodating space 1000 and has a plurality of through holes 1002 therein. The second side walls 102 connect to the first side wall 100, connect between the top cover 106 and the bottom cover 108, are located outside of the accommodating space 1000, and connect to each other in sequence. A chamber 104 is formed between the first side wall 100 and any one of the second side walls 102. In other words, the chambers 104 surround an outer side of the first side wall 100. In the embodiment, the first side wall 100 and the second side walls 102 are connecting parts of a one-piece object. Furthermore, the accommodating space 1000 is communicated with the chambers 104 through the through holes 1002 respectively. The fan 12 is rotatably disposed in the accommodating space 1000.

The centrifugal fan module 1 of the present disclosure can be disposed within a case of an electronic device, and can be configured to dissipate for plural electronic element in the electronic device. In the embodiment, the electronic device may be, such as, a personal computer, and the centrifugal fan module 1 can be configured to dissipate heat for a central processing unit (CPU) or a power supply in the electronic device. Of course, the disclosure herein is merely an example and is not tended to be limited for the application of the centrifugal fan module 1 and for the kind of the electronic device.

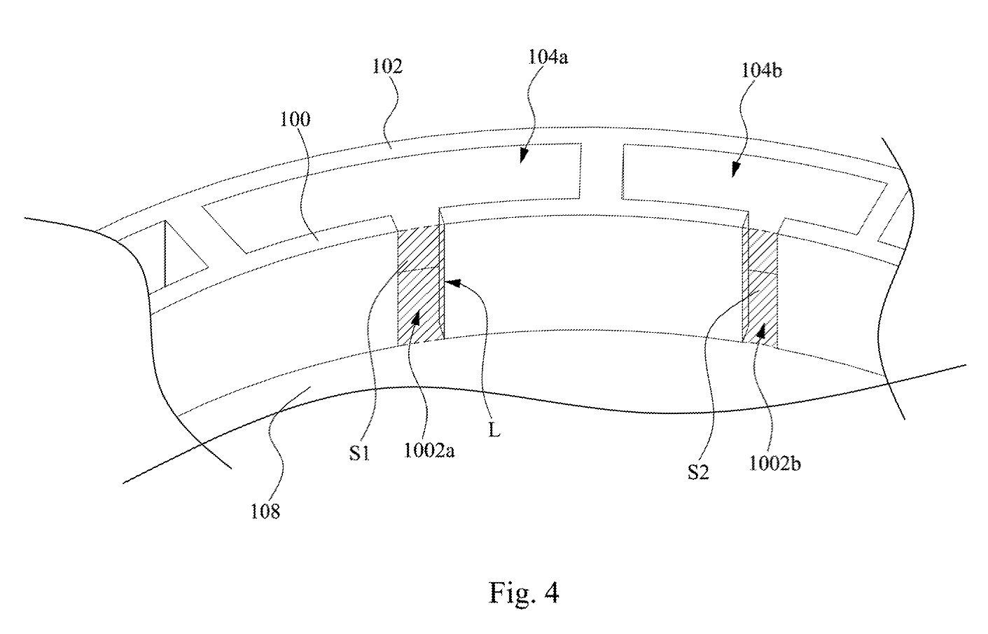

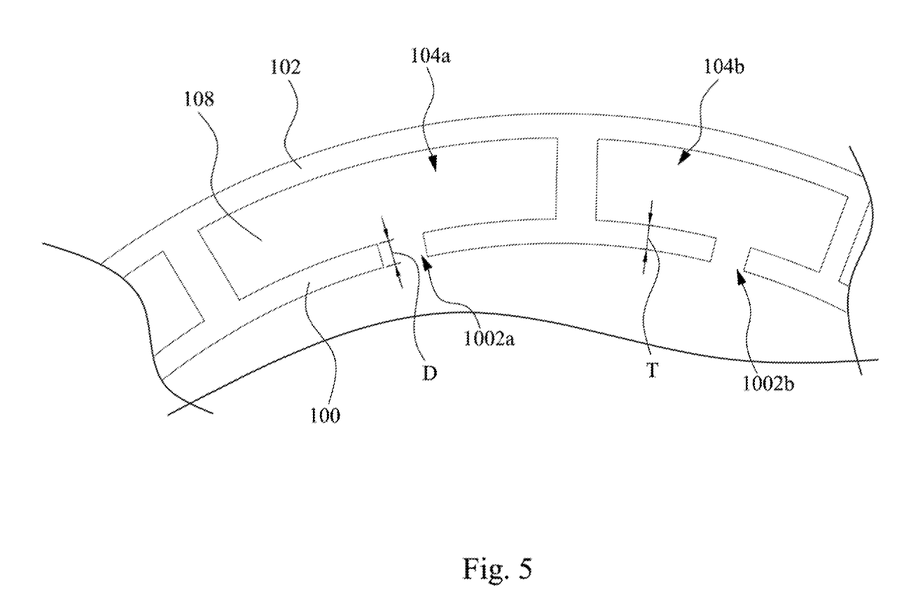

Reference is made to FIGS. 4 and 5. FIGS. 4 and 5 are a perspective view and a top view of a partial structure of a centrifugal fan module 1 according with some embodiments of the present disclosure respectively. In general, frequencies generated by the centrifugal fan module 1 at the time in operation bring about a large amount of energy in a plurality of frequency intervals. The centrifugal fan module 1 may reduce the volume of sound and absorb the energy of sound by the use of the Helmholtz resonance theory. When the natural frequency of one of the chambers 104 is substantially the same as a frequency generated by the centrifugal fan module 1 at the time in operation, the said one of the chamber 104 may have a resonance phenomenon. A friction between an air column in the chamber 104 and the chamber 104 generated by the resonance phenomenon may consume the energy of the in the aforementioned frequency, thereby enabling the centrifugal fan module 1 to reduce the volume of sound and absorb the energy of sound. Consequently, the centrifugal fan module 1 of the embodiment may reduce the volume of sound having a broader bandwidth by a plurality of chambers 104. Furthermore, the chambers 104 of the present disclosure surround the outer side of the first side wall 100, thereby reducing the volume of a sound in a designed frequency for a multi-angle range.

In some embodiments, one of the frequencies generated by the centrifugal fan module 1 at the time in operation has a strong frequency response. In the case, the natural frequency of at least two of the chambers 104 in the present disclosure may be designed to be the same, and said natural frequency is design to substantially be the same as said frequency having a strong frequency response, thereby reducing the volume of sound generated by the centrifugal fan module 1 effectively. Hence, a plurality of the chambers 104 having the same natural frequency can be used to reduce the volume of sound effectively.

In FIGS. 4 and 5, chambers 104a and 104b of the chambers 104 in the centrifugal fan module 1 are depicted. For example, each of the frequency f1 and the frequency f2 of the centrifugal fan module 1 at the time in operation may generate a larger volume of sound. The chambers 104a and the through hole 1002a of the centrifugal fan module 1, and the frequency f1 may be designed to satisfy the Helmholtz formula as the following equation, thereby reducing the volume of sound with frequency f1. Alternatively, the chambers 104b and the through hole 1002b of the centrifugal fan module 1, and the frequency f2 may be designed to satisfy the Helmholtz formula as the following equation, thereby reducing the volume of sound with frequency f2.

f1=fr1=c/2n(A1/V1D1)^{1/2}; and

f2=fr2=c/2n(A2/V2D2)^{1/2};

wherein c represents the speed of sound, V1 and V2 represent the volume of the chambers 104a and 104b respectively, A1 and A2 represent the section areas of the sections S1 and S2 of the through holes 1002a and 1002b respectively, and the sections S1 and S2 are substantially parallel to the first side wall 100 of the hosing 10, D1 and D2 represent the depths of the through holes 1002a and 1002b respectively, and the through holes 1002a and 1002b are substantially the same as the thickness T of the first side wall 100, fr1 and fr2 represent the resonance frequencies of the chambers 104a and 104b respectively. Furthermore, the volume V1 of the chamber 104a of the housing 10 is different from the volume V2 of the chamber 104b, but the present disclosure is not limited thereto. In some embodiments, as long as the chambers 104a and 104b have parameters which satisfy the design requirements as previous described, they can be applied the present disclosure.

Furthermore, the section area A1 of the through hole 1002a is different from the section area A2 of the through hole 1002b, but the present disclosure is not limited thereto. In the embodiment, the section of the through 1002 is a rectangular, but the present disclosure is not limited thereto. In some embodiments, the section of the through holes 1002 may be in other shapes, such as, a circular and a diamond shape. In the embodiment, two ends of a side L of the rectangular section abut the top cover 106 and the bottom cover 108 respectively. In other words, the length of the side L is substantially equal to a distance from the top cover 106 to the bottom cover 108.

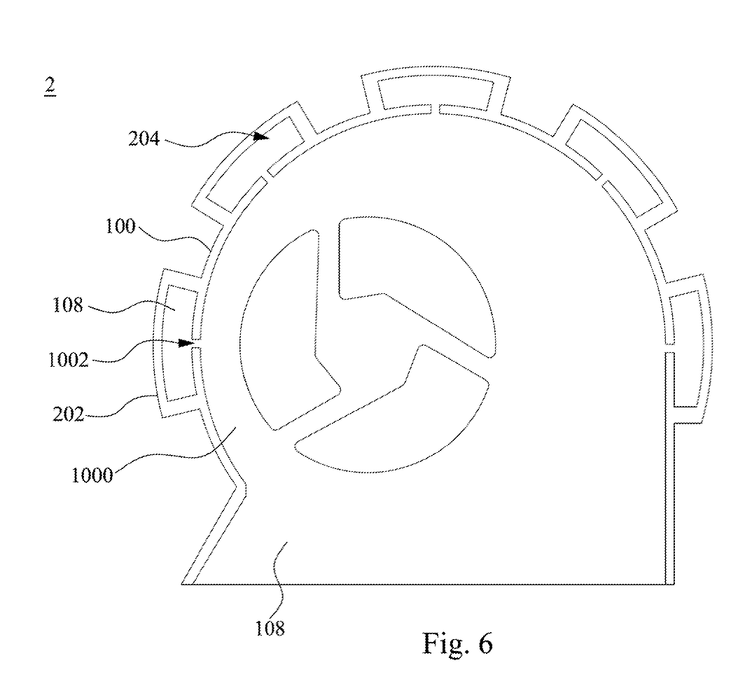

Reference is made to FIG. 6. FIG. 6 is a top view of a partial structure of a centrifugal fan module 2 according with some other embodiments of the present disclosure. It is understood that FIG. 6 has been simplified to omit a top cover 106 of a housing 10 and a fan 12 of the centrifugal fan module 2 for a better understanding of the embodiments of the present disclosure. As shown in FIG. 6, the structure and function of the elements and the relationship therebetween are substantially the same as the centrifugal fan module 1 in FIGS. 1-3, and the related detailed descriptions may refer to the foregoing paragraphs, and are not discussed again herein. Hence, the present disclosure may repeat reference numerals and/or letters in the examples as the previous embodiment. This repetition is for the purpose of simplicity and clarity and represents the same or similar elements, and the description of the same technical contents is omitted.

It is noted that, the difference between the present embodiment and that in FIGS. 1-3 are in that a plurality of second side wall 202 of the centrifugal fan module 2 are separated from each other. In other words, a distance between adjacent two of the chambers 204 in the centrifugal fan module 2 is larger than the thickness of the second side walls 202, and the chambers 204 separately surround the outer side of the first side wall 100. In the configuration, a position for each of the chambers 204 may be adjusted in response to the spatial configuration of the centrifugal fan module 2 in the housing 10, thereby enabling the chambers 204 be configured with the electronic elements in the electronic device, thereby making full use of the space within the electronic device. Furthermore, because the chambers 204 in the centrifugal fan module 2 are separately surround the outer side of the first side wall 100, the structure 1I of the centrifugal fan module 2 has a higher degree of flexibility, so that it provides a good resistance against vibration in an environment.

According to the foregoing recitations of the embodiments of the disclosure, it can be seen that the housing of the centrifugal fan module includes the top cover, the bottom cover, the first side wall, and a plurality of second side walls. A chamber is formed between the first side wall and any one of the second side walls, and the accommodating space is communicated with the chambers through the through holes respectively. In doing so, the size of the chambers and the through holes of the centrifugal fan module are designed in accordance with the volume of noise with a large bandwidth generated by the centrifugal fan module at the time in operation.

In the configuration, the centrifugal fan module of the present disclosure uses the Helmholtz resonance theory, in which the natural frequency of one of the chambers is substantially the same as a frequency generated by the centrifugal fan module at the time in operation, to consume the energy of sound in the aforementioned frequency, thereby reducing the volume of sound, and thereby enabling the centrifugal fan module to reduce the volume of noise and absorb the energy of noise. Consequently, the centrifugal fan module of the present disclosure may reduce the volume of noise having a broader bandwidth by a plurality of chambers. Furthermore, the chambers of the present disclosure surround the outer side of the first side wall, thereby reducing the volume of sound in design frequency for a multi-angle range.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A centrifugal fan module, comprising:
a housing, comprising:
a top cover;
a bottom cover;
a first side wall connected between the top cover and the bottom cover to surround and form an accommodating space and having a plurality of through holes therein; and
a plurality of second side walls connected between the top cover and the bottom cover, connected to the first side wall, and located outside of the accommodating space, wherein a chamber is formed between the first side wall and any one of the second side walls, and the accommodating space is communicated with the chambers through the through holes respectively; and
a fan disposed rotatably in the accommodating space.

2. The centrifugal fan module of claim 1, wherein at least two of the chambers have different volumes.

3. The centrifugal fan module of claim 1, wherein each of the through holes has a section, the section is substantially parallel to the first side wall, and at least two of the sections of the through holes have different areas.

4. The centrifugal fan module of claim 3, wherein the section is a rectangle, two ends of a side of the rectangle are adjacent to the top cover and the bottom cover respectively and connected to the top cover and the bottom cover.

5. The centrifugal fan module of claim 1, wherein one of the chambers has a volume, the through hole connected to the one of the chambers has a section and a depth, the section is substantially parallel to the first side wall and has a section area, the depth is substantially equal to a thickness of the first side wall, sound generated by the centrifugal fan module during operation has a sound speed and at least a frequency, and a resonance frequency satisfies the following equation:
fr=f=c/2n(A/VD)^{1/2},
wherein f represents the frequency of sound, fr represents the resonance frequency, c represents the sound speed, A represents the section area of the through hole, V represents the volume of the chamber, and D represents the depth of the through hole.

6. The centrifugal fan module of claim 5, wherein the resonance frequencies of at least two of the chambers are different.

7. The centrifugal fan module of claim 1, wherein the chambers surround an outer side of the first side wall.

8. The centrifugal fan module of claim 1, wherein the second side walls are sequentially connected to each other.

9. The centrifugal fan module of claim 1, wherein the first side wall and the second side walls are connecting parts of a one-piece object.
